(19) United States
(12) Patent Application Publication
(10) Pub. No.: US 2004/0017399 A1
(43) Pub. Date: Jan. 29, 2004

(54) Markers positioned in the trace of a logic analyzer snap to locations defined by clock transitions

(76) Inventors: Douglas James Beck, Colorado Springs, CO (US); Douglas Fred Robison, Colorado Springs, CO (US); John Howard Friedman, Colorado Springs, CO (US)

Correspondence Address: AGILENT TECHNOLOGIES, INC., Legal Department, DL429, Intellectual Property Administration, P. O. Box 7599, Loveland, CO, 80537-0599, US

(21) Appl. No.: 10/202,779

(22) Filed: Jul. 25, 2002

(51) Int. Cl. G09G 5/00

(52) U.S. Cl. 345/805; 345/771

(57) ABSTRACT

Placement position errors for a selected marker within a logic analyzer trace are avoided by allowing the operator to click within the region occupied by a waveform of interest, detecting the subsequent direction of horizontal mouse motion and combining that with the marker's current location to determine which signal transition within that waveform of interest would be encountered next by the selected marker as it moves in the detected direction. The selected marker is then automatically placed at that location. A marker can be selected by clicking on its icon in advance, or automatically as part of the waveform selection by clicking sufficiently close to a cursor portion of the marker as it passes through the waveform. A number of further considerations come into play if such a system is to be convenient to use and intuitive.

### BACKGROUND OF THE INVENTION

A logic analyzer is an item of electronic test equipment that records the logical transitions (as between one and zero, TRUE and FALSE) in a collection of one or more logic signals, in contrast with an oscilloscope, which records analog voltage values. There is yet another difference, and it is that the 'scoperecords its events as a function of time, while the logic analyzer captures data signal values only in step with transitions in a clock signal associated with those data signals. To be sure, a system composed of logic signals and the circuitry that makes them can malfunction in ways that involve transitions to or from voltage values that should never happen, or at times that are not allowed. Logic analyzer have developed ways to detect such impolite behavior (e.g., glitch detection). Once such behavior is detected the proper tool for further measurement and analysis might be a 'scope or a timing analyzer, as it is quite likely that some lack of proper hygiene in the electrical side of things is indicated, and a mere trace of the logical behavior will not contain all the relevant information. The usefulness of a logic analyzer is greatest when the underlying electrical aspects of the SUT (System Under Test) are not particularly suspect, and where we are instead interested in information about the logical states of the SUT over time. A “state” is a combination of logic values for one or more logic signals of interest, and will occur or change value only in response to transitions in the system clock signal. So, we might ask such things as “How long did it take from entrance to exit for this subroutine?”, “Did this instruction ever get executed?” or, “Why did (or didn't) the state machine visit this particular state?” These are all issues that can be investigated by assigning state values to collections of logic signals that represent fetched instructions, addresses, data, etc. The key point to appreciate is that if we display a waveform-like trace of the signals of interest, any changes in the trace will occur only in synchronism with transitions in the system clock signal. This is not hard to accept, since those familiar with logic analyzers will agree that they generally don't even acquire data at times other than such transitions in the system clock, anyway.

Modern logic analyzers are composed of some data acquisition hardware that is set up and operated under the control of a control program executed on a processor, in what is essentially a computer system. In fact, it is often the case that the control program is a special purpose application program running under a merchant operating system, such as one of the Windows products from Microsoft, or perhaps a unix-like operating system. There are many advantages for doing this, as it simplifies the task of saving and later restoring results, and of post-measurement processing of the results to perform analysis. It also lends itself to flexible display of the results. A logic waveform is simply a formatted way to present data found in an acquisition memory, and if a user wants it formatted this way one time and that way another, or wishes to zoom in or out, or pan along the trace, what better resource to have available than a window manager (i.e., a window based display subsystem, say, X11 or one of its variants) for a modern operating system. Furthermore, such systems are equipped to cooperate with screen pointing devices, such a mouse, trackball, or the like. Thus it is conventional for logic analyzers to have one or more markers (positionable cursors) that can be placed into the displayed trace results, with the aim of assisting in some post-acquisition measurement or analysis, such as the time or number of states occurring between two markers.

That is all well and good, but there are some aspects of conventional marker techniques for logic analyzers that make them harder to use than they ought to be. First, note that the display itself has a pixel resolution, and that even though a good many pixel positions along the trace are expected to get used in depicting the duration of even one state in the trace, the transitions in the displayed trace are (of necessity) quantized to pixel locations. This can act, in effect, as a form of rounding, since sampled signal transitions in the SUT are not constrained to occur with any predetermined relationship relative to those pixels. Second, a screen pointer icon controlled by a mouse or other pointing device can also only be rendered in discrete locations, as defined by the grid of pixel positions. The mouse or other input device has associated with it a unit of screen pointer icon (or, in our case, marker) movement (an impetus for displacement), which might range from a sub-pixel amount to an amount corresponding to several pixels. Now, the window manager for the operating system can be expected reconcile these differing resolutions. It can decide which pixel locations should depict transitions and much how much marker movement (in pixels) to produce for a given amount of pointing device input. Some compromise may be needed here, as it is neither safe nor reasonable to expect that such underlying resolutions will always be the same, or that one will always be nice multiples of the other. In and of itself, such compromise is not particularly objectionable in the standard computer environment, and often remains unnoticed, as the screen pointer (say, a tilted arrow) is large compared to the “error” and the capture range for deciding if something has been “clicked on” is larger still.

But if we are positioning a marker in the trace of a logic analyzer, it is no longer of assistance for the operating system or its window manager to be willing to place a marker arbitrarily and according to a compromise appropriate to another environment. For if it does (as is conventional), then we as users have to expend considerable extra effort to get the marker (which may be vertical line only a pixel or two wide) right at the correct location, since the operating system/window manager knows nothing of logic signal transitions in an SUT that are constrained to occur only in synchronism with associated clock signal transitions. As far as the operating system is concerned, you (accidentally?) moved the mouse a little, so it moved the marker over by just a pixel, or maybe by two or three. You the user can tell that's not right, and are vexed to get it back where it belongs, at least from a visual perspective. The manual for this piece of equipment has long since disappeared and you are not absolutely certain that the time between the two markers (or other measurement related to those markers) will be reported as the time between the intended SUT signal transitions, or instead as the would-be time along the time axis for the markers as they actually appear on the screen (which, as you have positioned them, are somewhat misplaced). You don't want to take a chance about how to interpret the measurement, and an experiment to find out right now (in the middle of that measurement) is inconvenient. So you fuss with the pointer input device to get the marker right where it belongs. Even so, your fine motor skills are taxed by the crowded condition of your cubicle and the fact the logic analyzer is perched atop a shelf, or is on a roll-around cart with only three of four wheels touching an uneven floor, and, try as you will, there is just not an easy way to administer fine movements to the marker control system. After some aggravation you finally succeed, but notice that the reported measurement value does not seem reasonable. After some further effort it is discovered that slight mouse motion can change the reported measurement value, without changing the apparent locations of the markers on the display. Well, . . . Rats! Upon consideration we realize that the trouble is that we are zoomed out too far, and that the resolution for mouse motion is coarse compared to what the data would have it if could be displayed with a pixel resolution corresponding to the actual samples in memory. The only solution is to zoom in, position the markers within a display of more favorable resolution, and then zoom back out. That is a fix, but: (a) you have to know to do it; and, (b) it is definitely inconvenient. So here we have an expensive (say, between ten thousand and a million dollars) piece of equipment hooked up, and whose marker mechanism makes it all too easy for us to unwittingly make an erroneous measurement. That is a major “gotcha”. “There has to be a better way,” you say. What to do?

### SUMMARY OF THE INVENTION

A solution to the problem of avoiding placement errors in the position of a selected marker within a logic analyzer trace is to allow the operator to click within the region occupied by a waveform of interest, detect the subsequent direction of horizontal mouse motion and combine that with the current location of the selected marker to determine which signal transition within that waveform of interest would be encountered next by the selected marker as it moves in the detected direction. The selected marker is then automatically placed at that location. This avoids the problem of different marker positions having the same apparent location in the display can that arise when the waveform is viewed fully zoomed out. A marker can be selected by clicking on its icon in advance, or automatically as part of the waveform selection by clicking sufficiently close to a cursor portion of the marker as it passes through the waveform. A number of further considerations come into play if such a system is to be convenient to use and intuitive. The automatic placement of markers can also be adapted for use with waveforms displayed by digital oscilloscopes.

### BRIEF DESCRIPTION OF THE DRAWINGS

FIG. 1 is a line drawing representation of a prior art display of a logic analyzer showing waveform traces of several signals and two markers M1 and M2 positioned thereon;

FIG. 2 is a line drawing representation similar to that of FIG. 1, but where a screen pointer icon has been positioned (as with a mouse) within the waveform of a signal of interest and a mouse button pressed and held, followed by a determination that the mouse/screen pointer icon have subsequently been moved to the left, whereupon a heavy arrow indicates the direction in which and/or the next signal transition where the selected marker (in this case M1) will automatically be positioned;

FIG. 3 is a line drawing representation similar to that of FIG. 2, with the marker M1 having been automatically positioned, upon release of the mouse button, to the transition indicated in FIG. 2;

FIG. 4 is a line drawing representation similar to that of FIG. 2, but where the heavy arrow is further to the left, indicating direction along which the next transition will automatically become the position of marker M1;

FIG. 5 is a line drawing representation similar to that of FIG. 4, but with the marker M1 having been automatically positioned to the next signal transition further to the left;

FIG. 6 is a line drawing representation similar to those of the preceding figures, except that the selected marker is now M2, that the signal of interest is now a composite indication of several signals comprising a bus, and that the heavy arrow now indicates detected mouse motion to the right while the mouse button is held down;

FIG. 7 is a line drawing representation similar to that of FIG. 6, but with the marker M2 automatically positioned to the next transition to the right in the trace of the bus; and

FIG. 8 is simplified flowcharting that illustrates the internal operation of a logic analyzer or digital oscilloscope that incorporates automatic placement of selected markers onto transitions in selected waveforms and along a selected direction.

### DESCRIPTION OF A PREFERRED EMBODIMENT

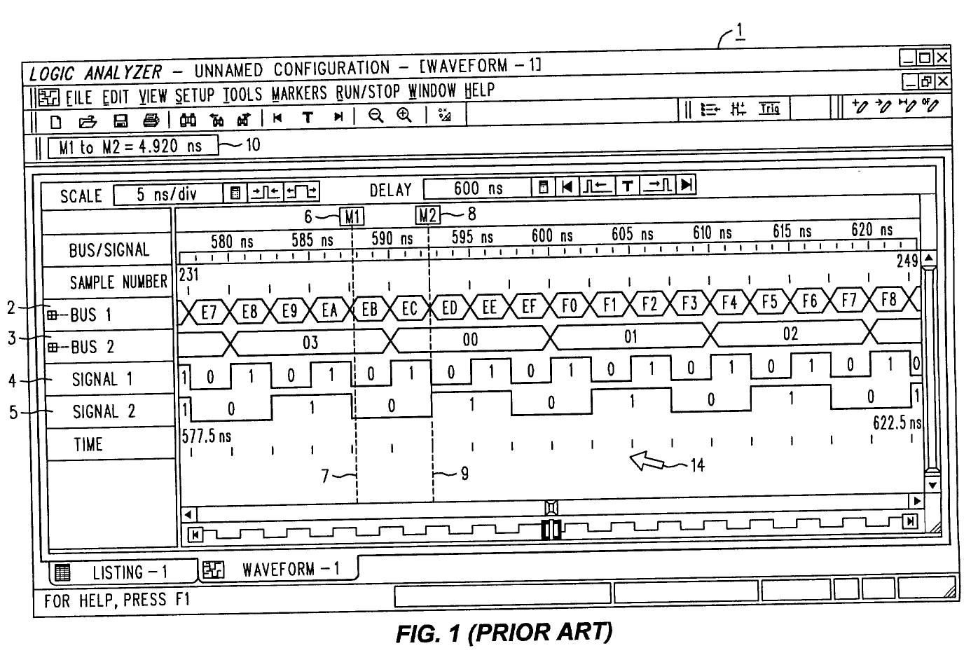

Refer now to FIG. 1, wherein is shown a line drawing representation 1 of a prior art waveform display of logic signals measured by a logic analyzer (not itself shown). The signals displayed in a waveform format, as opposed to a tabular one, rather as if for an oscilloscope. Those signals are identified by labels on the left as “BUS 1 ” (2), “BUS 2” (3), “SIGNAL 1 ” (4) and “SIGNAL 2” (5). Notice also the two markers M1 and M2, each of which includes a marker icon (6 for M1 and 8 for M2) and a dotted line portion (7 for M1 and 9 for M2) that may serve as vertical cursors that traverse horizontally along the time axis. In conventional fashion, these markers (cursors) can be used to indicate locations in the waveform whose intervening time or number of states can be reported by the logic analyzer. So, for example, we see in box 10 that the time between markers M1 and M2 is 4.920 ns. Note also the presence of normal screen pointer icon 14, which moves in accordance with mouse motion.

The conventional method of positioning markers such as M1 or M2 is by moving them in response to rotation of a knob on the front panel (as in some older 'scopes) or, more recently, by sustained clicking upon and subsequent dragging of their image by mouse (or other screen pointer input device) motion. Thus, the conventional method of positioning M1 is to perform a sustained click on either its icon 6 or its vertical cursor 7, and then move the mouse horizontally until the marker M1 is shown at the desired location. This can require the fine motion control that is sometimes difficult to achieve in practice, as previously mentioned in the Background. Furthermore, depending upon the circumstances, accurate placement of the markers may require zooming in and then back out again to avoid the situation where a zoomed out display shows the same apparent marker location for a range of marker locations that are actually different, as also mentioned in the Background.

It will be appreciated that, while there may indeed be situations where is it desired to position the markers at locations that appear unchanging along the shape of a waveform (which might change much more slowly than the rate at which samples are taken), it will often be the case that the desired marker position is at a transition in some waveform of interest. We now proceed with an explanation of how that may be accomplished automatically.

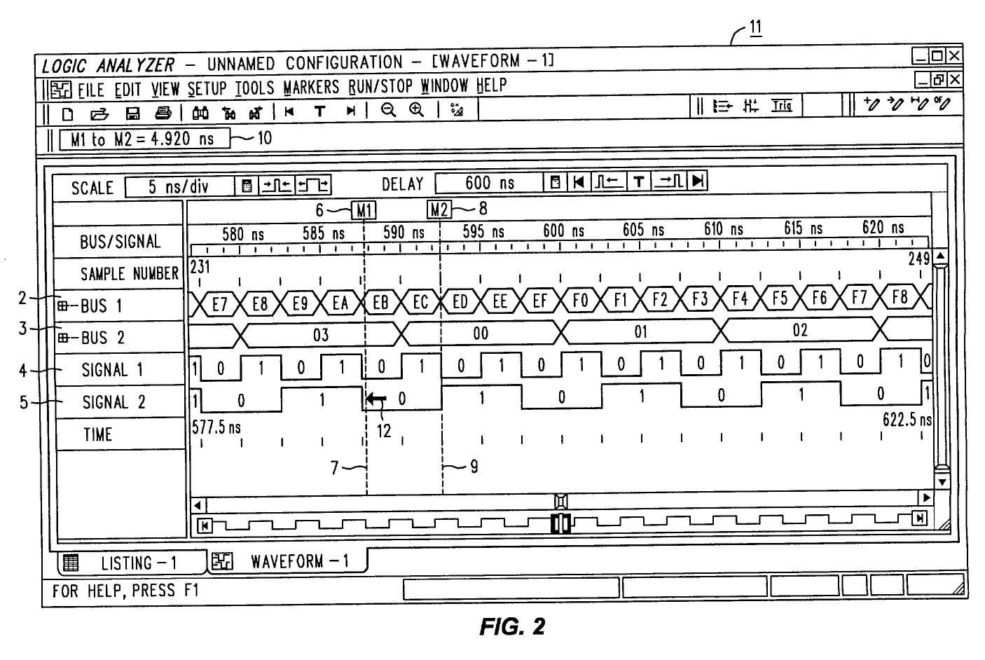

Refer now to FIG. 2, which is a line drawing representation 11 similar to that of FIG. 1, except that an arrow 12 appears within the vertical extent of the trace of “SIGNAL 2” (5). There are several things to point out in connection with this situation. First, three things have been selected. They are: (a) marker M1; (b), the signal named “SIGNAL 2” (5); and the direction “to the left” (earlier in time). That is, the operator has done something that has elected those choices from among other possibilities, with the implication that, if he ratifies those choices, the marker M1 will be automatically moved in a useful manner to a predictable location that is a location of interest. (It will be noted that marker M1 is not presently positioned over a transition in “SIGNAL 2”.) Let us examine these items, one at a time.

First, the operator might choose to move either one of the markers. He selects the marker to be moved, either in isolation ahead of time, or in conjunction with some other choice. To select the marker M1 ahead of time he might simply click on the icon 6, or sufficiently close to the vertical dotted cursor line 7, anywhere along its length. An indication that marker M1 is selected can be provided, if desired, by changing the displayed appearance of all or part of that marker. It could, for example, be displayed in a special color, intensified, or as blinking on and off, or as alternating between two colors. And, it might not be necessary to selected it (again) at all, if it remains selected from a previous operation. In any event, the figure does not include any particular visual device to indicate that M1 has been selected, but will be appreciated that it has been, according to what is set out above, or just below.

Second, if we are to automatically position a marker according to a transition in a particular waveform, then we need to indicate which waveform has the honor of containing the transition. Mouse motion produces corresponding motion of a screen pointer icon (14 in FIG. 1, but which does not appear in FIG. 2, owing to the state of affairs) that is typically a tilted arrow or an oversized “capital I”, depending upon the nature of the window manager for the operating system in use. It is, for example, that screen pointer icon (14) that may be positioned over the M1 icon 6 to click upon it to select M1. What we say now is that if that screen pointer icon 14 is positioned within the vertical extent of the display allocated to “SIGNAL 2” and then the mouse is clicked, that “SIGNAL 2” becomes the selected signal, and the usual screen pointer icon 14 changes to the arrow 12 (whose shape is chosen to be distinguishable from the normal screen pointer icon). Now, it will be further appreciated that if the operator positions the normal screen pointer icon 14 within the vertical extent of “SIGNAL 2” and on or sufficiently close to the vertical line 7 for marker M1, and then clicks, then marker M1 and signal “SIGNAL 2” can be selected at the same time by that single operation. The selection of “SIGNAL 2” can be indicated by any of the mechanisms used to indicate selection of M1, as noted above, which may be applied to just the label portion, the waveform portion, or both, as desired. However, it will also be appreciated that it is also sufficient simply to rely on the indication provided by arrow 12: it lies within the vertical extent of signal “SIGNAL 2”, thus indicating that “SIGNAL 2” (5) is the data signal whose waveform has been selected.

Third, the arrow 12 points to the left. This is significant, as it might point to the right, instead. That it points left means that an automatic marker movement is imminent, and that if allowed to proceed (choices are ratified), that automatic marker movement will be from where it already is to the next transition to the left in the selected waveform (in this case, “SIGNAL 2”). Now, there are two ways that the arrow direction can be determined. First, it might be the case that it is appropriate to re-use its previous direction from an earlier automatic marker movement (an example will be given below), or, some mouse motion was used to compel pointing in a particular direction.

It will be appreciated that, once arrow 12 appears as part of the display, the normal screen pointer icon 14 disappears in favor of arrow 12.

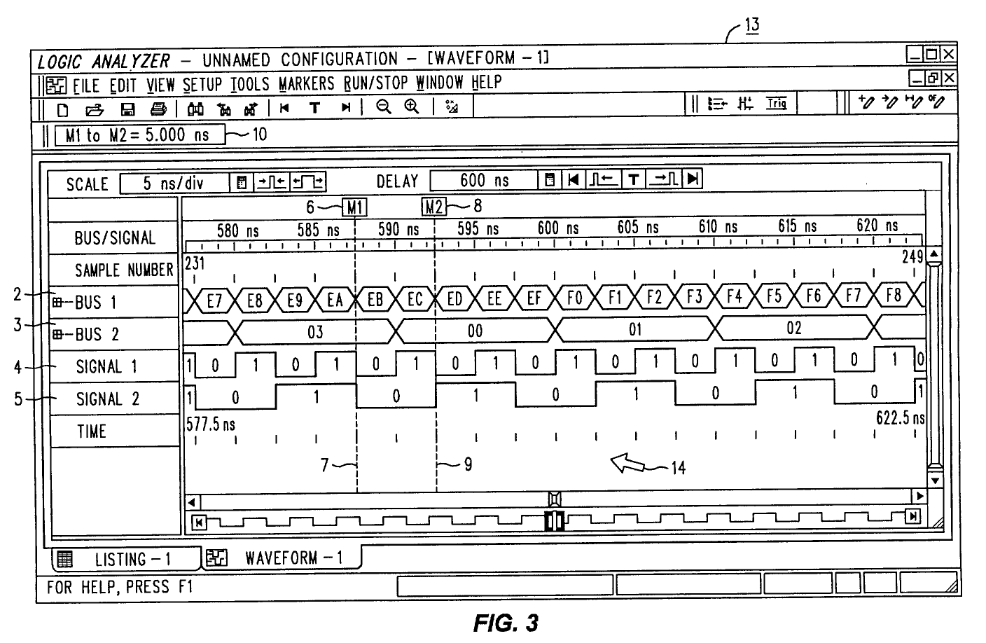

In any event, once these three choices described above are ratified, the marker M1 is automatically moved to the next transition on the left within “SIGNAL 2”. See display 13 in FIG. 3, and note that vertical cursor line 7 is now directly over that transition to the left and that box 10 now indicates a tidy 5.000 ns. Also note that arrow 12 has disappeared from the screen, and that mouse motion is once again associated with movement of a normal screen pointer icon 14 (shown having been moved off to some arbitrary location).

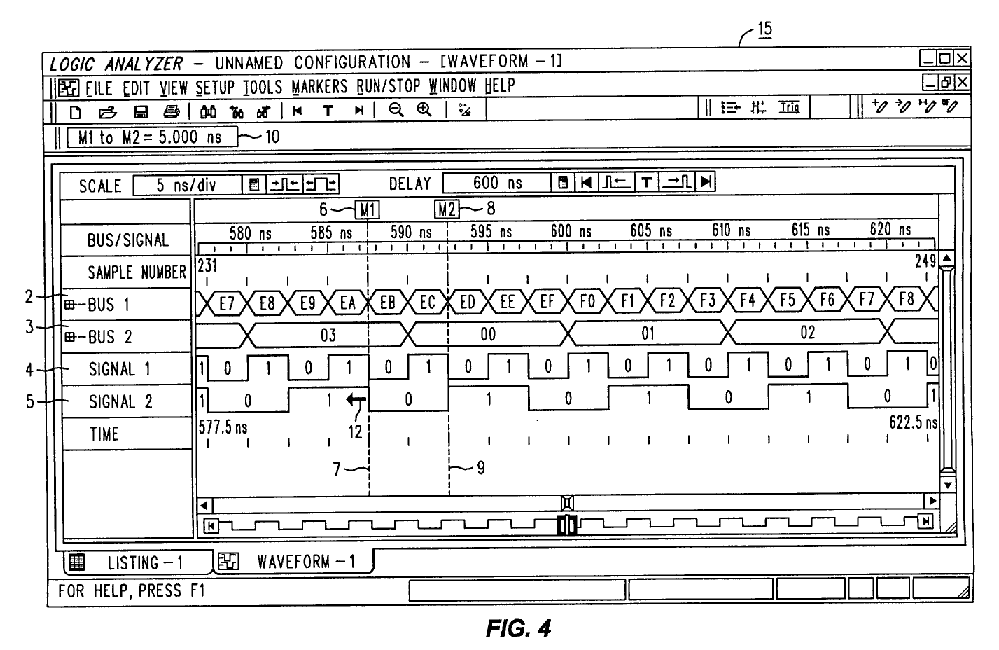

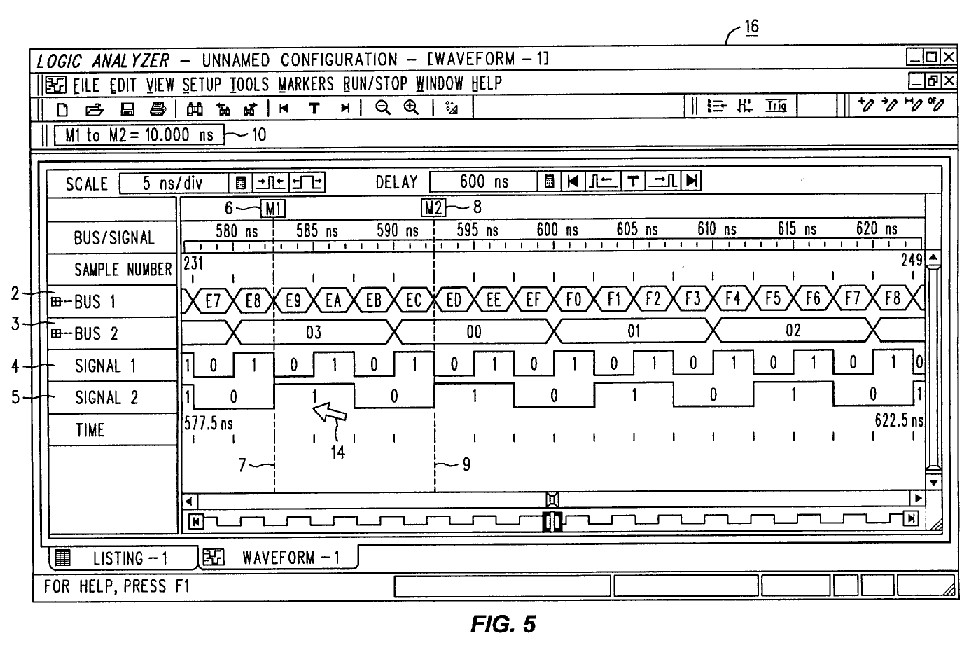

At this point it is appropriate that we tidy all this up and show how it can be accomplished by simple intuitive mouse motion in conjunction with the operation of a single mouse button. The next several figures will serve as instructive examples. Accordingly, FIG. 4 illustrates a display 15 where the normal screen pointer 14 was positioned (by mouse motion) within the extent of “SIGNAL 2” (so as to not de-select it and select another instead) and then clicked with a sustained pressing of the mouse button, without moving the mouse. The previous direction of movement for M1 (to the left) remains in effect, and arrow 12 re-appears, pointing to the left and positioned (a) to the right of the next transition to the left (so it can point leftward toward it) and (b) to the left of the next transition on the right (so as to be between two transitions). If there should be insufficient room for the arrow 12, then it is simply superimposed with its pointed tip in the proper location. If the operator intends to change the direction that arrow 12 points he may simply move the mouse in the other direction, and the direction in which arrow 12 points will change. The operator can, while holding the mouse button down, move even further in the desired direction, passing over intervening transitions that are not of interest, and leave the arrow 12 in a location that will snap to the next transition in that direction, skipping the intervening ones already passed over. He can even alter the selected waveform by moving the mouse up or down to position the arrow 12 with the vertical extent of a different waveform. This is possible since, once which marker is selected, the selections of direction and of which waveform are independent selections, and can be made and re-made in any order. In any event, when he is satisfied with the three choices guiding the automatic marker movement mechanism (which marker, which signal, which direction), he releases the mouse button (ratification of the choices) and the position of the selected marker automatically moves to the next transition in the selected waveform. See display 16 in FIG. 5, and note that cursor line 7 has now moved over to the preceding transition, and that the value reported in box 10 is now 10.000 ns. Furthermore, normal screen pointer icon 14 has reappeared, and arrow 12 is gone, indicating that no automatic marker movement operation is pending.

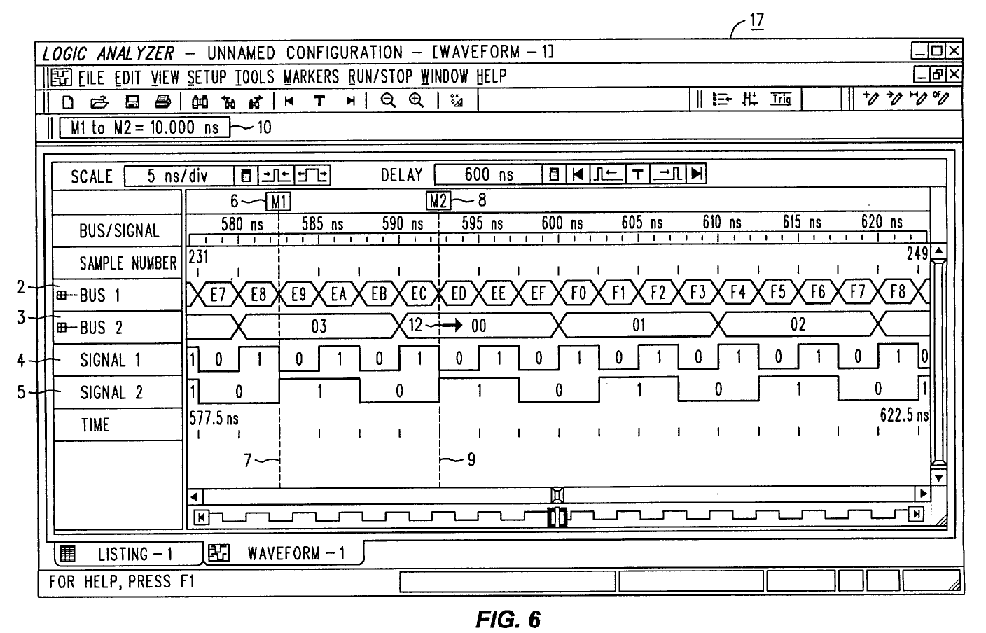

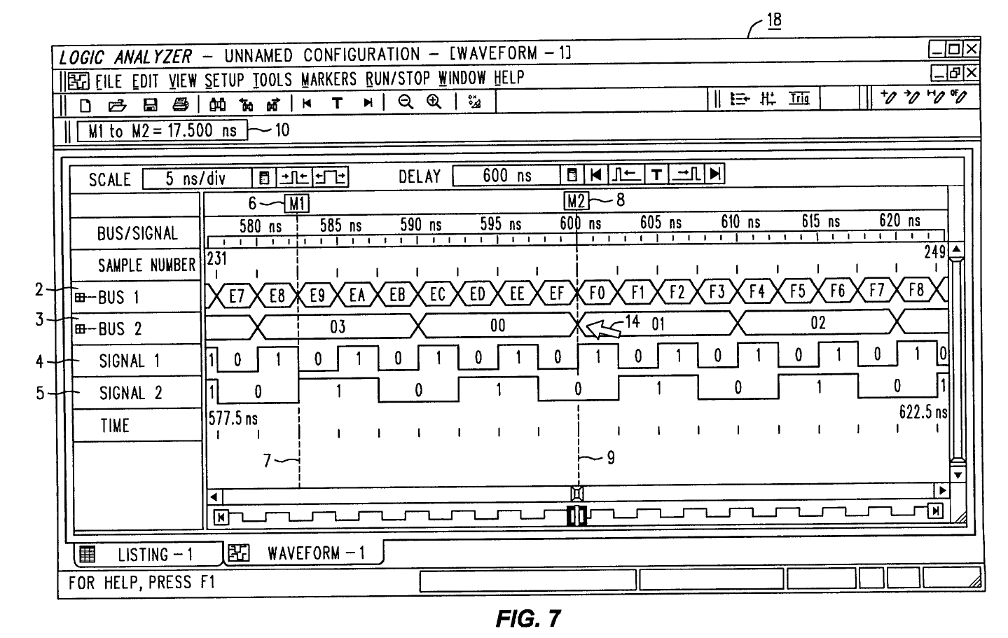

Now consider the example shown in connection with FIG. 6. It is a display 17 of a situation where the operator has moved the normal screen pointer icon 14 (not shown, as it has already been replaced by arrow 12) into the vertical extent of the waveform representing “BUS 2” (3), and then performs a sustained press of the mouse button. He has either previously separately selected M2 and the selected marker, or, has selected it in a joint operation during the selection of “BUS 2”. The arrow 12 points to the right, which is either the previous direction that M2 was moved, or, is the direction the mouse was moved after the sustained click was initiated. In any event, once the operator is satisfied, he ratifies the choices by releasing the mouse button. The marker M2 now snaps automatically to the next transition ion the right in the waveform for the bus signals “BUS 2” (3). See display 18 in FIG. 7. Note that arrow 12 is gone and that normal screen pointer icon 14 has re-appeared. See also box 10, where the reported value is now 17.500 ns.

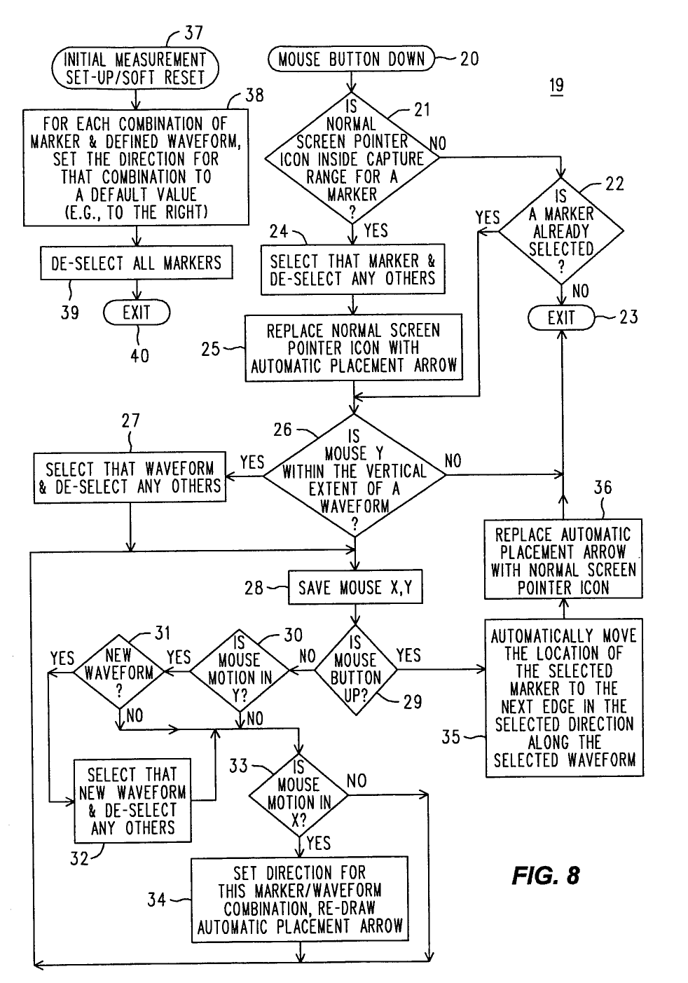

Now refer to FIG. 8, which contains simplified flowcharting 19 that illustrates a preferred manner in which the user interface for automatic marker placement may be implemented by firmware or software executed by an apparatus such as a logic analyzer (or perhaps a digital oscilloscope) that utilizes the feature of automatic placement of a selected marker at transitions in a selected waveform and along a selected direction.

We begin by noting segment 37-40. It begins whenever there is an initial measurement set-up or a soft reset (37). When that happens (which is akin to a “power-up” condition for the automatic marker placement feature we are interested in) step 38 sets each combination of defined waveform (displayed signal, such as 2-5) and positionable marker to a default direction, which might be, say, “to the right” or perhaps even “undefined”. After that, step 39 de-selects all markers, whereupon there is an exit at 40 back to an outer environment.

Assuming now that some waveforms (e.g., 2-5) have been defined, a measurement cycle has been made and a display is visible, such as described for FIGS. 1-7, consider what happens when the button on the mouse (or a switch associated with some other screen pointer input device) is pressed. That general circumstance is indicated at 20, where the legend is “mouse button down”. When that condition occurs a qualifier 21 asks if the normal screen pointer icon is within the capture range of any one of the markers. (The capture range is the conventional concept associated with the familiar drag and drop mechanism found in most window manager sub-systems. The “drag” part will be dealt with later, and we don't really care about the “drop” part; we are deciding if the operator has “clicked on” a marker. In any event, conventional calls to the operating system take care of finding out the answer at step 21.) If the answer is NO, then the location of the icon moved by the mouse (14/12) is away from any marker, and a transition occurs to step 22, where we enquire if there is already a marked selected. If there is, then we may have to deal with waveform and direction selection by a transition to step 26 (described in due course), but if there is not, then nothing of interest is occurring, and we EXIT via 23 back to an outer environment. To return to step 21, if the answer is YES, then we are obliged to select that marker and de-select any others, as indicated at step 24. The act of “selecting” a marker amounts to setting a bit in some data structure associated with it, or perhaps one that is associated with all of the markers.

Once a marker is selected the normal screen pointer icon (14) is replaced at step 25 with an icon associated with automatic placement of markers, which we have previously called arrow 12. Note that arrow 12 will have a direction, which will either be the default one or one that has been previously been set by operations described further below.

At this point we reach step 26, either from step 25 directly, or from the YES result of step 22, as previously noted. Step 26 is the beginning a waveform and direction selection process. In step 26 we ask if the Y value of the mouse position lies within the vertical extent of a waveform displayed on the screen. This is readily determined, since (previously existing) mechanism that builds the waveforms for display knows, in pixel address form, what vertical range of pixel addresses are allocated to each waveform, and the mouse position is likewise understood as an address in pixels. The question asked in step 26 amounts to determining if the Y value of the mouse position lies within a range of Y values stored in a data structure associated with a waveform. If it does not (NO), then nothing interesting is happening, and we EXIT via 23. If, on the other hand, the answer at step 26 is YES, then step 27 selects that waveform as the selected waveform, and also de-selects any other waveforms. That leads to step 28, where the (X, Y) coordinates of the mouse position are saved for use in motion detection described below and associated with setting direction.

After step 28, step 29 determines if the mouse button is up. If it is (YES), then it is time to perform an automatic positioning of the selected marker. That is accomplished by step 35, and is followed by step 36, which removes the automatic placement arrow 12 and replaces it with the normal screen pointer icon 14.

The operation performed in step 35 is, similar to the test associated with step 26, an investigation of data stored in a data structure. The nature of the data structure will be understood to be the conventional ones know for use with either a logic analyzer or a digital oscilloscope. Such a data structure is associated with a particular waveform and contains data describing its shape, organized as a sequence of Y values (to be understood as associated with an implicit sequence of X values). In the logic analyzer case the sequence of Y values is limited to logical values of “1” or “0”, TRUE or FALSE, HIGH or LOW, etc., most probably expressed as single bits each. This is, of course, a result of the threshold comparison done at the level of probing the SUT. In the 'scope case there will be a sequence of multi-bit values provided by an analog to digital conversion mechanism. In either case the idea is to start scanning the data structure at the location corresponding to the current mouse X value, and in the selected direction (more about that below), looking for a transition. In the logic analyzer case that is fairly easy to do, since the value at the start of the search is one of only two possibilities, and we are looking for the occurrence of the other. When we find such a transition, it will have location in the data structure that is readily converted to a value for the associated marker, which we may then use as if we had positioned the marker ourselves to that location. In the 'scope case we will need to add the process of detecting where on a slope a transition is deemed to occur. That kind of process step is conventional in the oscilloscope arts, and we need not describe it in isolation.

Following step 36 (where the normal screen pointer icon 14 was restored) an EXIT occurs via 23, and the automatic marker placement operation is complete.

However, it might have been the case back at step 29 that the mouse button was still down. If that were so (NO), then step 30 checks for mouse motion in the Y direction. If there was some (YES), then step 31 enquires if we have moved the mouse position to lie (vertically) within the extent of a different waveform. If not (NO), then we can proceed to step 33, but if we have (YES), then we need to visit step 32, where that new waveform is selected and any others are de-selected. In either case we next visit step 33, where we enquire about mouse motion in the X direction. If there has been mouse motion in the X direction (YES), then we need in step 34 to set a direction for this combination of selected marker and selected waveform. Following that, for if there has been X no motion (NO), then we can transition back to step 28, to repeat all that this until the mouse button is up and an automatic move for a marker is to be made.

In conclusion, then, these things should be noted. First, there is no requirement that the markers to be automatically placed be located in the same selected waveform. They can each be in different waveforms; see the example of FIGS. 6 and 7. It is clear that each marker is individually positionable within a selectable waveform, regardless of which waveform a different marker is associated with. Next, we have shown only two markers, but upon consideration it will be appreciated that there can be more than two. What this means for the nature of the measurements being made cannot be said; it possible that four markers is simply two pairs of markers, with each pair being for a different measurement. On the other hand, there is nothing that says someone won't develop a single measurement that uses the locations of three or four markers as its input. And lastly, we wish to emphasize that although we have concentrated on the case where the waveform display is for a logic analyzer, that is not by any means a necessity. An alternative is that the waveform display may be for a digital oscilloscope. Also, it could easily be for a timing analyzer (especially so, since it, like the logic analyzer, stores data as logic values rather than as digitized voltages (or currents)).

We claim:

1. A method of automatically positioning markers within a display containing a waveform, the method comprising the steps of:
(a) determining that a button associated with a screen pointer device is pressed;
(b) selecting a first marker from among a plurality thereof as a marker to be automatically positioned, the selection performed in response to pressing the button associated with the screen pointing device while a screen pointer icon also has a specified spatial relationship with a displayed image of the first marker;
(c) subsequent to steps (a) and (b), determining that the location of the screen pointer icon lies within the vertical extent of the waveform;
(d) upon an affirmative determination in step (c), selecting the waveform as the waveform within which automatic marker positioning will be enabled;
(e) specifying a selected direction along the waveform and in which automatic positioning of the selected marker is to occur;
(f) determining that the button associated with the screen pointing device has been released; and
(g) subsequent to step (f), moving, in the selected direction, the location of the selected marker to the next transition in the selected waveform.

2. A method as in claim 1 wherein there are at least two waveforms, one of which is the waveform selected in step (d).

3. A method as in claim 1 wherein step (e) further comprises the step of detecting screen pointer device motion along an abscissa direction of the waveform.

4. A method as in claim 1 further comprising a step (h) of detecting screen pointer device motion along an ordinate direction of the waveform and wherein instances of steps (c) and (d) occur subsequent to a detection performed by step (h).

5. A method as in claim 1 wherein step (g) further comprises the step of investigating data stored in a data structure associated with the waveform selected in step (d).

6. A method as in claim 1 wherein the display containing a waveform is for a logic analyzer.

7. A method as in claim 1 wherein the display containing a waveform is for a timing analyzer.

8. A method as in claim 1 wherein the display containing a waveform is for a digital oscilloscope.
